(19) United States
(12) Patent Application Publication
(10) Pub. No.: US 2021/0056591 A1
(43) Pub. Date: Feb. 25, 2021

(54) COMPUTER SYSTEM AND METHOD FOR AUTOMATICALLY OPTIMIZING SELECTION OF MEDIA UNITS

(71) Applicant: Xandr Inc., New York, NY (US)

(72) Inventors: Peter Campbell Doe, New York, NY (US); Marco A. Montes de Oca, New York, NY (US)

(73) Assignee: Xandr Inc., New York, NY (US)

(21) Appl. No.: 16/999,768

(22) Filed: Aug. 21, 2020

Related U.S. Application Data
(60) Provisional application No. 62/890,822, filed on Aug. 23, 2019.

(51) Int. Cl. G06Q 30/02

(52) U.S. Cl. CPC G06Q 30/0272; G06Q 30/0276; G06Q 30/0247; G06Q 30/0249

(57) ABSTRACT

Aspects of the subject disclosure may include, for example, identifying an initial set of content schedule constraints including an initial plurality of values for two or more of price, available inventory, target audience, media content, number of impressions, placement dates, and placement times; generating a preliminary advertising schedule based on the initial set of content schedule constraints; calculating reach and average frequency based on the preliminary advertising schedule, resulting in a first calculated reach and a first calculated average frequency; updating one or more of the initial plurality of values of the initial set of content schedule constraints based on the first calculated reach and the first calculated average frequency, the updating resulting in an updated set of content schedule constraints, the updated set of content schedule constraints having one or more values of only some constituent content schedule constraints thereof differ from one or more values of corresponding content schedule constraints of the initial set of content schedule constraints; and generating a first updated advertising schedule based on the updated set of content schedule constraints. Other embodiments are disclosed.

### CROSS REFERENCE TO RELATED APPLICATION(S)

This application claims priority to U.S. Provisional Application No. 62/890,822, filed Aug. 23, 2019. All sections of the aforementioned application(s) and/or patent(s) are incorporated herein by reference in their entirety.

### FIELD OF THE DISCLOSURE

The subject disclosure relates to a computer system and method for automatically optimizing selection of media units.

### BACKGROUND

“Linear television” refers to television (TV) that is watched with the originally broadcast advertising inserted in ad breaks, including live pre-recorded and video on demand (VOD). This is in contrast to dynamically inserted advertising, also referred to as addressable. The TV advertisement marketplace consists of buyers (e.g., TV advertising agencies) and sellers (e.g., TV content producers and distributors). A linear TV advertising campaign includes a series of video clips (each of which is referred to as a “creative”) placed in available time slots that sellers sell to buyers. Three related quantities describe, at a high level, the effectiveness of a linear TV advertising campaign: impressions, reach, and frequency. For example, if 10 people watch a particular creative, and each such person watched that creative two times over the course of an advertising campaign, then the campaign will have a reach of 10 people, collect 20 impressions, and have an average frequency equal to 2. The mathematical relationship between these three quantities is:

Impressions=Reach*Average Frequency (1)

The quantity “impressions” may be replaced by another quantity that typically is referred to as ratings, which are the ratio of impressions to the estimated size of the target segment (also referred to as the “universe estimate”), expressed as a percentage. In the example above, if the estimated size of the target segment is 1,000, then the rating is 2 (100×20/1,000). In the description herein, impressions and ratings may be used interchangeably unless otherwise noted.

An advertiser (buyer) typically is interested in maximizing impressions, subject to a number of constraints, such as budget, dates, times of day, separation between transmission times, and combination of TV networks, channels and programs, among others. Since these constraints specify absolute or relative minimum and maximum limits on the fraction of the budget to spend on, or impressions to collect from various potential ad placements, they effectively limit the maximum value of impressions for a particular TV campaign. Maximizing impressions within these constraints can however deliver excessive frequency, with some persons being exposed a very large number of times to the advertising. This may make those viewers turn away from the advertised product or service, and thereby achieve a result that is the opposite of that desired and intended by the advertiser. The ideal outcome, from the advertiser's perspective, is one which balances reach and average frequency. In some cases this may mean maximizing impressions, in some cases this may mean maximizing reach, and in other cases this may mean finding a solution somewhere between these.

Achieving such a balance between reach and average frequency efficiently and in a wide range of cases is a challenging problem.

### BRIEF DESCRIPTION OF THE DRAWINGS

Reference will now be made to the accompanying drawings, which are not necessarily drawn to scale, and wherein:

FIG. 1 is a dataflow diagram of a system 100 for optimizing reach in an advertising campaign according to one embodiment. Optimization for impressions occurs by default.

FIG. 2 is a flowchart of a method performed by the system of FIG. 1 according to one embodiment.

FIG. 3A depicts an illustrative embodiment of a method in accordance with various aspects described herein.

FIG. 3B depicts an illustrative embodiment of a method in accordance with various aspects described herein.

FIG. 3C depicts an illustrative embodiment of a method in accordance with various aspects described herein.

FIG. 4 is a block diagram of an example, non-limiting embodiment of a computing environment in accordance with various aspects described herein.

### DETAILED DESCRIPTION

In various embodiments, a computerized system automatically optimizes an advertising campaign in a variety of ways, such as optimizing for the ratings of the advertising campaign or by optimizing for the reach of the advertising campaign. Such automated optimization enables advertisers to achieve their goal, subject to the constraints of the advertising campaign (such as the budget and target networks of the advertising campaign).

For example, various embodiments can perform optimization which:
a. Optimizes for reach only. Such optimization can be performed, for example, when the main goal of the user (e.g., buyer) is to obtain a proposal that satisfies all of the provided constraints (such as any of the constraints described above) while maximizing target reach, regardless of the total number of rating points.
b. Optimizes for both reach and ratings. Such optimization can be performed, for example, when the user (e.g., buyer) is interested in obtaining a high reach but also in keeping ratings as high as possible.
c. Optimizes for ratings only. This is the traditional goal of maximizing the total number of times an advertisement is watched. Again, this optimization can be done while simultaneously respecting budget and desired allocation constraints.

In various embodiments, users can employ disclosed mechanisms to perform optimization according to one or more of the optimization goals (a, b, c) described above. It may be reasonable, for example, for the user to select the “reach only” optimization goal first. The reach obtained by applying the “reach only” optimization goal, however, is usually higher than the reach obtained by applying the “reach and ratings” optimization goal, although at the cost of fewer rating points than the “reach and ratings” optimization goal. A user may, therefore, wish to employ mechanisms (such as described herein) to perform multiple optimization goals (e.g., a, b and/or c above), to compare the results and/or to select one of the optimization goals based on the user's preference for reach in comparison to ratings.

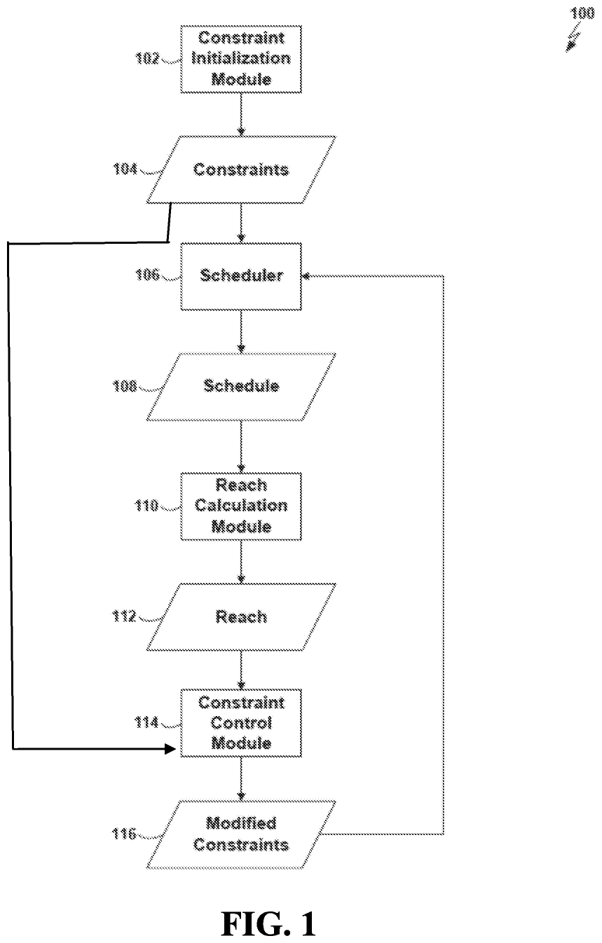

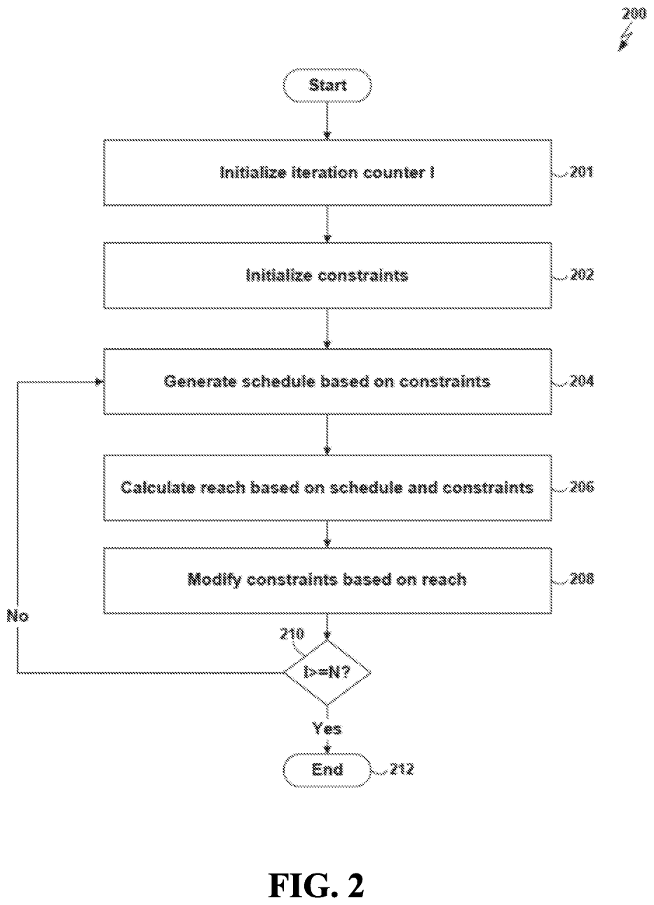

Referring to FIG. 1, a dataflow diagram is shown of a system 100 for optimizing the number of impressions in an advertising campaign according to one embodiment. Referring to FIG. 2, a flowchart is shown of a method 200 performed by the system 100 of FIG. 1 according to one embodiment. The system 100 of FIG. 1 and the method 200 of FIG. 2 are applicable to both the “reach only” and “reach and ratings” goals described above.

The method 200 initializes an iteration count I to zero (FIG. 2, operation 201).

The system 100 includes a constraint initialization module 102, which initializes and outputs a set of constraints 104 (see also, FIG. 2, operation 202). The constraints 104 can include one or more constraints, such as one or more of any of the constraints disclosed herein. In one example, the set of constraints that this constraint initialization module 102 outputs are those that neither the seller nor the buyer entered as part of the campaign's requirements. In another example, the set of constraints that this constraint initialization module 102 outputs can be automatically manipulated by the system 100 in operation 114. The constraint initialization module 102 can initialize the set of constraints 104 in any of a variety of ways. For example, the constraint initialization module 102 can receive input from a user (not shown) which specifies both the constraint(s) to be included in the constraints 104 and a corresponding value for each such constraint. For example, the user input can indicate that the constraints 104 are to include a budget constraint having a value of $500,000. In response to receiving such input, the constraint initialization module 102 can include, in the constraints 104, the constraint(s) and corresponding value(s) specified by the input. This is merely an example of a way in which the constraint initialization module 102 can initialize the constraints 104. As other examples, the constraint initialization module 102 can iterate over a set of constraints and corresponding values, use machine learning to automatically generate constraints and corresponding values based on historical data that characterize successful campaigns, or any combination thereof. Although the constraints 104 may be referred to herein in the plural, it should be understood that the constraints 104 may include only a single constraint.

The system 100 also includes a scheduler 106, which receives the constraints 104 as input, and which generates a schedule 108 as output that maximizes impressions and satisfies all of the constraints 104 (see also, FIG. 2, operation 204). A variety of techniques that the scheduler 106 can use to generate the schedule 108 are described in detail elsewhere herein.

The system 100 also includes a reach calculation module 110, which receives the schedule 108 as input, and which calculates a reach 112 based on the schedule 108 (see also, FIG. 2, operation 206). The reach calculation module 110 can calculate the reach 112 at the network-daypart level (though other groupings are also possible). For example, the reach calculation module 110 can calculate a separate value of the reach 112 for each of a plurality of network-daypart combinations. As this implies, the reach 112 can be a plurality of reaches for the schedule 108. The reach calculation module 112 calculates average frequency in addition to reach. Therefore, any reference herein to the reach calculation module 112 calculating reach should be understood to apply equally to the reach calculation module 112 calculating both reach and average frequency.

The system 100 also includes a constraint control module 114, which receives the constraints 104 and the reach 112 and average frequency as inputs, and which modifies the constraints 104 based on the other inputs to produce modified constraints 116 as output (see also, FIG. 2, operation 208). The output of the constraint control module 114 can include a list of the constraints (which can, for example, be identified by their constraint IDs) whose upper bounds need to be updated, and the magnitudes of the updated upper bounds. The constraint control module 114 can perform the indicated updates on the constraints 104 to produce the modified constraints 116.

Referring now to FIG. 2, the method 200 determines whether the value of the iteration count I is greater than or equal to some predetermined maximum number of iterations N (see FIG. 2, operation 210). If I>=N, then the method 200 terminates (see FIG. 2 operation 212). Otherwise (i.e., if I<N), the method 200 returns to operation 204, in which the scheduler 106 produces a new schedule based on the modified constraints 116, and the remaining operations 206-210 repeat until I>=N. As this implies, the method 200 can produce any number of schedules (some or all of which can be different from each other in any of a variety of ways), can produce any number of values of reach (some or all of which can be different from each other in any of a variety of ways), and can produce any number of sets of constraints (some or all of which can be different from each other in any of a variety of ways).

Note that instead of iterating N times, the method 200 can instead iterate until at least some predetermined amount of time has passed since the method 200 began. This can be implemented, for example, by initializing a timer in operation 201 instead of a counter, and by determining, in operation 210, whether the current value of the timer (which can increase in value in correspondence with the passage of time) is greater than or equal to some predetermined maximum amount of time.

As yet another example, the method 200 can instead terminate when the rate of change in the reach 112 falls below some predetermined threshold value, where the rate of change in the reach 112 can be measured, for example, by the difference in value of the reach 112 from one iteration of the method 200 to the next (over two or more such iterations).

Regardless of the termination criterion that is used, the most recently produced schedule, or the “best” schedule according to some qualitative and quantitative criteria, or a subset of all the produced schedules by the system 100 and method 200 when the method 200 terminates is output by the system 100 and method 200 as their final output.

A wide variety of scheduling techniques are known in the art, and the scheduler 106 can use any of a variety of techniques. In addition, however, in various embodiments, the scheduler 106 uses improved techniques which enable the system 100 and method 200 to significantly improve the resulting schedule 108, as measured by the coverage of the advertising in the schedule 108, where “coverage” refers to the number of persons or homes that fall within the desired target that are exposed to at least one airing of the schedule 108.

In general, the scheduler 106 implements a scheduling algorithm which executes a loop in which only some of the constraints 104 differ from one iteration of the loop to the next. Various embodiments can make this feature as efficient as possible by indexing the right hand sides of the constraints 104 (in particular upper limits). The constraints (within the constraints 104) that need modification may not be contained in the initial formulation of the problem (e.g., may not be part of the set of the user-provided constraints), but may instead be added to the constraints 104 by the reach optimization process based on the contents of the cartesian product of the inventory and the campaigns being scheduled.

As a specific example, each of the constraints 104 can include the following parameters, each of which can have a corresponding value:
a. Constraint ID: any data that acts as a unique identifier of the constraint.
b. Campaign ID: a unique identifier for the schedule.
c. Inventory label: data that identifies a feature of the inventory. For example, the name of the network and/or daypart to which the constraint applies. In various embodiments, the scheduler 106 will only apply the constraint to network-daypart combinations specified by the inventory label.
d. Inventory value: this is the value of the inventory feature. In the case of a network-daypart constraint, this label could take values of the form “Network X—Prime time”.
e. Measurement: the constraint's measurement. This is the units the constraint values are measured in. For example, a constraint can determine the maximum number of dollars to spend on a network, or it could set the minimum number of target segment impressions that are desired from a certain show, or it could specify the number of advertisements placed during a certain daypart. In the context of an embodiment of a method described herein, the measurement of the constraints under the algorithm's control can be based on the target segment impressions, the target being a segment of the population defined in terms of demographics (or some other behavioral or attitudinal classifications).
f. Target value: the ideal value for the inventory that matches the inventory label and value in terms of the measurement units.
g. Target minimum: the minimum value for the inventory that matches the inventory label and value in terms of the measurement units.
h. Target maximum: the maximum value for the inventory that matches the inventory label and value in terms of the measurement units.
i. Relative to: If this constraint is relative to another constraint (e.g., “of the dollars spent on network X, which may not be known in advance, allocate 25% during daytime”), then this parameter points to the other constraint. Otherwise, this parameter has a null value.
j. Elasticity flag: this is a binary value which indicates whether the constraint's minimum and maximum values may be violated by the schedule 108 that the scheduler 106 generates based on the constraints 104. As the name implies, elastic constraints' limits “stretch” just enough to accommodate the allocation of impression/dollars but not more than what is needed.

The set of parameters listed above is merely an example and does not constitute a limitation. Various embodiments can use constraints having parameters other than those listed above.

In various embodiments, the constraint control module 114 can only make modifications to the constraints 104 which relax those constraints 104. In various embodiments, the scheduler 106 can place a non-integer number of advertisements in a single slot in intermediate iterations of the method 200, but not in the final iteration of the schedule 108 that is output by the method 200 (i.e., such a final iteration of the schedule 108 only contains integer numbers of placements in the slots in the schedule 108 in such embodiments).

As described above, although various embodiments may optimize for different goals, the system 100 and method 200 shown and described in connection with FIGS. 1 and 2 are applicable to optimization for reach and/or ratings optimization goals, although the process of optimizing for the various goals may differ somewhat in their execution paths, as will be illustrated by the following examples.

First, consider an example in which the set of constraints 104 under the control of the method 200 is represented by the following table, which also shows the reach and average frequency decomposition:

| network_daypart | target_impressions | target_reach | avg_frequency |
|---|---|---|---|
| 1 | NA | NA | NA |
| 2 | 2700 | 1000 | 2.7 |
| 3 | 2340 | 1300 | 1.8 |
| 4 | 7000 | 2000 | 3.5 |

The constraint control module 114 can calculate, based on a table such as the one above, the mean average frequency from the values in the columns target_impressions, and target_reach, e.g., mean_avg_frequency=(2700+2340+7000)/(1000+1300+2000)=2.8.

The constraint control module 114 can calculate, for each network-daypart in a table such as the one above, a maximum number of impressions (max_target_imps_at_mean) targeting a frequency equal to the mean_avg_frequency. The following table illustrates an example of the results of such calculations of the value of the column max_target_imps_at_mean, which involves, for each network-daypart (i.e., row in the table below), dividing the value of target_impressions by the value of mean_avg_frequency (which is equal to 2.8 in this example):

| network_daypart | target_impressions | target_reach | avg_frequency | max_target_imps_at_mean |
|---|---|---|---|---|
| 1 | NA | NA | NA | NA |
| 2 | 2700 | 1000 | 2.7 | 2700/2.8 = 375.939 |
| 3 | 2340 | 1300 | 1.8 | 2000/2.8 = 751.87 |
| 4 | 7000 | 2000 | 3.5 | 5000/2.8 = 1879.69 |

The constraint control module 114 can, for each network-daypart, calculate the corresponding reach proportion, which involves, for each network-daypart (i.e., row in the table above), dividing the value of target_reach for that network-daypart by the sum of all of the values of target_reach in the table:

| network_daypart | target_impressions | target_reach | avg_frequency | max_target_imps_at_mean | reach_proportion |
|---|---|---|---|---|---|
| 1 | NA | NA | NA | NA | NA |
| 2 | 2700 | 1000 | 2.7 | 375.939 | 1000/(1000 + 1300 + 2000) = 0.232 |
| 3 | 2340 | 1300 | 1.8 | 751.87 | 1300/(1000 + 1300 + 2000) = 0.302 |
| 4 | 7000 | 2000 | 3.5 | 1879.69 | 2000/(1000 + 1300 + 2000) = 0.465 |

The constraint control module 114 can, for each network-daypart, calculate a proportional number of impressions collected at the same rate as reach, by multiplying the sum of all values of target_impressions in the table by the value of reach_proportion for that network-daypart. This quantity will be referred to herein as max_prop_target_imps.

| network_daypart | target_impressions | target_reach | avg_frequency | max_target_imps_at_mean | reach_proportion | max_prop_target_imps |
|---|---|---|---|---|---|---|
| 1 | NA | NA | NA | NA | NA | NA |
| 2 | 2700 | 1000 | 2.7 | 375.939 | 0.232 | (2700 + 2340 + |
| | | | | | | 7000)*0.232 = 2793.28 |
| 3 | 2340 | 1300 | 1.8 | 751.87 | 0.302 | (2700 + 2340 + |
| | | | | | | 7000)*0.302 = 3636.08 |
| 4 | 7000 | 2000 | 3.5 | 1879.69 | 0.465 | (2700 + 2340 + |
| | | | | | | 70001*0.465 = 5598.6 |

The constraint control module 114 can determine which of the constraints 104 to control in the current iteration. This can be performed, for example, by selecting the network-dayparts for which the value of avg_frequency>mean_avg_frequency. An example of this is shown in the table below, in which network-daypart 4 is selected for constraint control because its avg_frequency is greater than the value of mean_avg_frequency:

| network_daypart | target_impressions | target_reach | avg_frequency | max_target_imps_at_mean | reach_proportion | max_prop_target_imps |
|---|---|---|---|---|---|---|
| 1 | NA | NA | NA | NA | NA | NA |
| 2 | 2700 | 1000 | 2.7 | 375.939 | 0.232 | 2793.28 |
| 3 | 2340 | 1300 | 1.8 | 751.87 | 0.302 | 3636.08 |
| 4 | 7000 | 2000 | 3.5 | 1879.69 | 0.465 | 5598.6 |

The next step, which produces as output a list of constraints (e.g., constraint IDs) to be modified by the constraint control module 114 and the new values of such constraints, can vary depending on whether the system 100 and method 200 are optimizing for reach only or for both reach and ratings. In either case, the list of constraints to be modified can be generated in the manner described above.

If the system 100 and method 200 are optimizing for reach only, then the constraint control module 114 can calculate the new maximum limit of the selected constraints by choosing the maximum of max_target_imps_at_mean and max_prop_target_imps for each of the selected constraints. For example, using the values in the tables above, this would result in the following new maximum values for the selected constraints (i.e., network-daypart 4 in the example above):

| network_daypart | max_value |
|---|---|
| 4 | max(1879.69, 5598.6) = 5598.6 |

If the system 100 and method 200 are optimizing for both reach and ratings, then the constraint control module 114 can calculate the new maximum limit of the selected constraints by: (1) selecting the constraint that has not been modified in any way during the previous iterations (from among the constraints selected above) with the maximum average frequency and (2) setting the new max_value of that constraint to be equal to the value of max_target_imps_at_mean.

Regardless of which of these two methods are used to select the new maximum values of the modified constraints 116 in the next iteration of the method 200, the method 200 can then continue to the next iteration in the manner described above.

The final output of the system 100 and method 200 is the version of the schedule 108 which has the highest reach, regardless of the iteration of the method 200 at which that version of the schedule 108 is found. As this implies, the version of the schedule 108 that is output by the system 100 and method 200 may not be the version of the schedule 108 that is produced in the final iteration of the method 200. As this further implies, during each iteration of the method 200, the system 100 and method 200 can compute the full reach of the schedule 108 in addition to computing separate reaches for each network-daypart in the schedule 108.

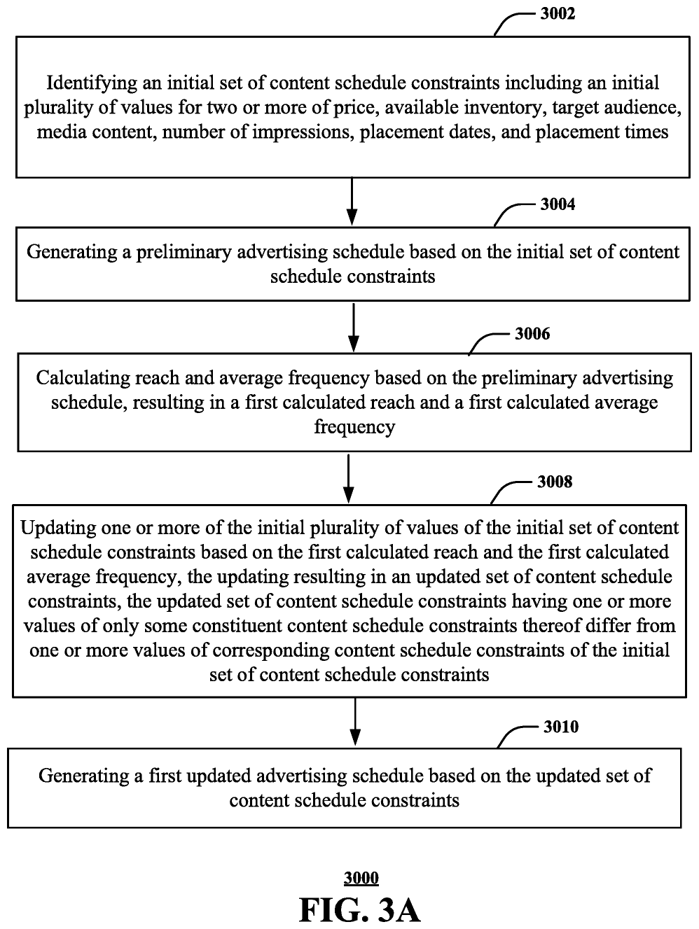

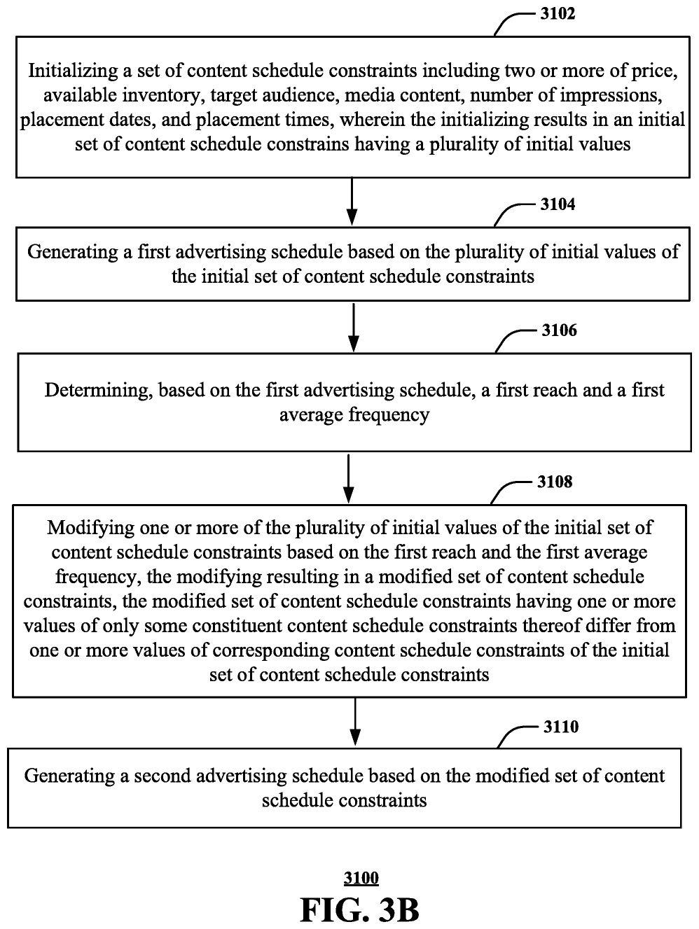

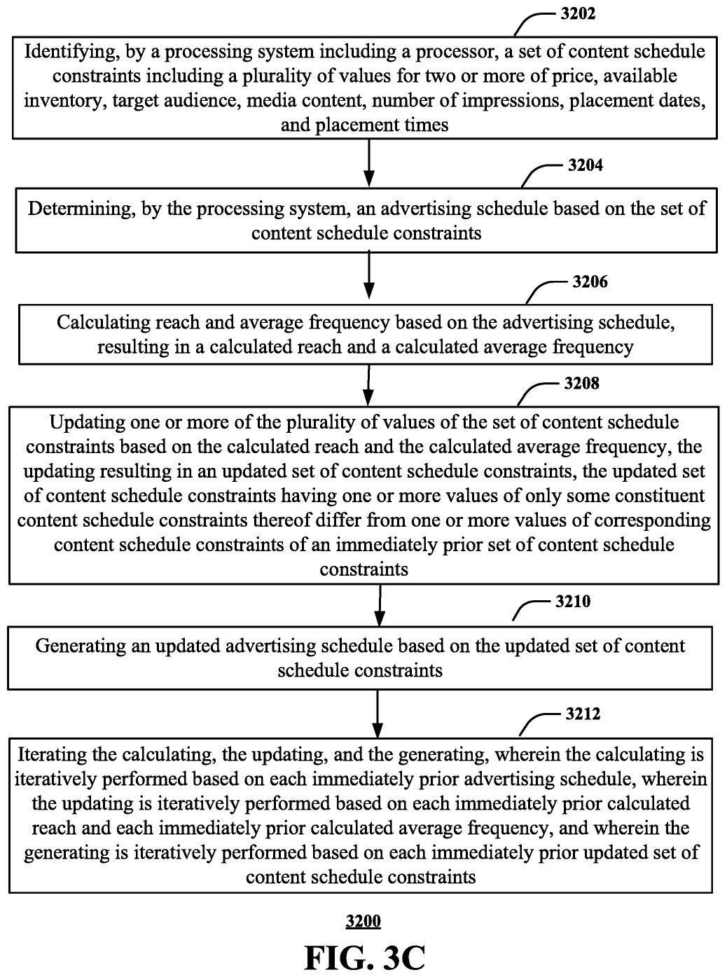

Referring now to FIG. 3A, various steps of a method 3000 according to an embodiment are shown. As seen in this FIG. 3A, step 3002 comprises identifying an initial set of content schedule constraints including an initial plurality of values for two or more of price, available inventory, target audience, media content, number of impressions, placement dates, and placement times. Next, step 3004 comprises generating a preliminary advertising schedule based on the initial set of content schedule constraints. Next, step 3006 comprises calculating reach and average frequency based on the preliminary advertising schedule, resulting in a first calculated reach and a first calculated average frequency. Next, step 3008 comprises updating one or more of the initial plurality of values of the initial set of content schedule constraints based on the first calculated reach and the first calculated average frequency, the updating resulting in an updated set of content schedule constraints, the updated set of content schedule constraints having one or more values of only some constituent content schedule constraints thereof differ from one or more values of corresponding content schedule constraints of the initial set of content schedule constraints. Next, step 3010 comprises generating a first updated advertising schedule based on the updated set of content schedule constraints.

While for purposes of simplicity of explanation, the respective processes are shown and described as a series of blocks in FIG. 3A, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein

Referring now to FIG. 3B, various steps of a method 3100 according to an embodiment are shown. As seen in this FIG. 3B, step 3102 comprises initializing a set of content schedule constraints including two or more of price, available inventory, target audience, media content, number of impressions, placement dates, and placement times, wherein the initializing results in an initial set of content schedule constraints having a plurality of initial values. Next, step 3104 comprises generating a first advertising schedule based on the plurality of initial values of the initial set of content schedule constraints. Next, step 3106 comprises determining, based on the first advertising schedule, a first reach and a first average frequency. Next, step 3108 comprises modifying one or more of the plurality of initial values of the initial set of content schedule constraints based on the first reach and the first average frequency, the modifying resulting in a modified set of content schedule constraints, the modified set of content schedule constraints having one or more values of only some constituent content schedule constraints thereof differ from one or more values of corresponding content schedule constraints of the initial set of content schedule constraints. Next, step 3110 comprises generating a second advertising schedule based on the modified set of content schedule constraints.

While for purposes of simplicity of explanation, the respective processes are shown and described as a series of blocks in FIG. 3B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein

Referring now to FIG. 3C, various steps of a method 3200 according to an embodiment are shown. As seen in this FIG. 3C, step 3202 comprises identifying, by a processing system including a processor, a set of content schedule constraints including a plurality of values for two or more of price, available inventory, target audience, media content, number of impressions, placement dates, and placement times. Next, step 3204 comprises determining, by the processing system, an advertising schedule based on the set of content schedule constraints. Next, step 3206 comprises calculating reach and average frequency based on the advertising schedule, resulting in a calculated reach and a calculated average frequency. Next, step 3208 comprises updating one or more of the plurality of values of the set of content schedule constraints based on the calculated reach and the calculated average frequency, the updating resulting in an updated set of content schedule constraints, the updated set of content schedule constraints having one or more values of only some constituent content schedule constraints thereof differ from one or more values of corresponding content schedule constraints of an immediately prior set of content schedule constraints. Next, step 3210 comprises generating an updated advertising schedule based on the updated set of content schedule constraints. Next, step 3212 comprises iterating the calculating, the updating, and the generating, wherein the calculating is iteratively performed based on each immediately prior updated advertising schedule, wherein the updating is iteratively performed based on each immediately prior calculated reach and each immediately prior calculated average frequency, and wherein the generating is iteratively performed based on each immediately prior updated set of content schedule constraints.

While for purposes of simplicity of explanation, the respective processes are shown and described as a series of blocks in FIG. 3C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, various embodiments can provide for optimizing for ratings and then optimizing for reach.

As described herein, various embodiments can provide for iterating (e.g., changing constraints and/or changing constraint values).

As described herein, various embodiments can provide for: (a) initial selection of advertisements across different networks/dayparts; (b) identifying where there is waste (e.g., too many advertisements and/or too much frequency); (c) optimizing—for example, put (e.g., daypart units) somewhere else to increase reach; (d) iterating (b), (c) and/or (d).

In one embodiment, a method comprises:
(A) identifying a set of content schedule constraints including at least one of price, available inventory, target audience, media content, number of impressions, and placement dates and/or times;
(B) using a non-linear selection method to automatically generate a selection of an advertising schedule based on the set of content schedule constraints, comprising:
   (B)(1) using a scheduler to execute a scheduling algorithm in a loop in which only some of the set of content schedule constraints differ between iterations of the loop, thereby generating a preliminary schedule;
   (B)(2) calculating reach and average frequency based on the preliminary schedule; and
   (B)(3) updating the set of content schedule constraints based on the calculated reach and average frequency.

In one example, (B) above comprises optimizing the advertising schedule for both reach and ratings.

In another example, (B) above comprises optimizing the advertising schedule for reach only.

In another example, (B) above comprises optimizing the advertising schedule for ratings only.

One advantage of various embodiments is that such embodiments can deliver a key advertising requirement, namely improved coverage of an advertising target. Various embodiments satisfy this requirement automatically in a real world application, using a media owner's actual available inventory, and selecting the schedule's units in minutes. The size of the inventory (often ˜tens of thousands of possible ad placements) and the number of constraints targeted by a campaign (often ˜thousands of constraints) can make the computations described herein impractical via mental/manual methods.

As described herein, various embodiments can provide a computerized system that automatically optimizes an advertising campaign in a variety of ways, such as optimizing for the ratings of the advertising campaign or by optimizing for the reach of the advertising campaign. Automated optimization provided by various embodiments enables advertisers to achieve their goal, subject to the constraints of the advertising campaign, such as the budget and target networks of the advertising campaign

It is to be understood that although particular embodiments have been described, such embodiments are provided as illustrative only. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described herein may be implemented, for example, in hardware, one or more computer programs tangibly stored on one or more computer-readable media, firmware, or any combination thereof. The techniques described herein may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Various embodiments include features which are only possible and/or feasible to implement with the use of one or more computers, computer processors, and/or other elements of a computer system. Such features are either impossible or impractical to implement mentally and/or manually. For example, various embodiments can automatically apply a variety of scaling factors to a unit CPM distribution using a multi-step process that would be impossible or impractical to implement mentally and/or manually. More generally, the problem of scheduling television advertisements belongs to a class of problems known to be computationally hard (see, e.g., “The complexity of scheduling TV commercials,” Electronic Notes in Theoretical Computer Science, Vol. 40, pages 162-185 (2001), Klemens Hagele and Colm Dunlaing and Soren Riis). A human, therefore, would find it overwhelming and, as a practical matter, impossible to schedule (using mental and/or manual processes only) a large number of television advertisements within the applicable temporal and other constraints.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below can be implemented in any programming language, such as assembly language, machine language, a high-level procedural programming language, or an object-oriented programming language. The programming language can, for example, be a compiled or interpreted programming language.

Each such computer program can be implemented in a computer program product tangibly embodied in a machine-readable storage device for execution by a computer processor. Method steps can be performed by one or more computer processors executing a program tangibly embodied on a computer-readable medium to perform functions by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing can be supplemented by, or incorporated in, specially-designed ASICs (application-specific integrated circuits) or FPGAs (Field-Programmable Gate Arrays). A computer can generally also receive (read) programs and data from, and write (store) programs and data to, a storage medium such as an internal disk or a removable disk. Various embodiments can be used in conjunction with any digital print engine or marking engine, display monitor, or other raster output device capable of producing color or gray scale pixels on paper, film, display screen, or other output medium.

Any data disclosed herein can be implemented, for example, in one or more data structures tangibly stored on a medium. Various embodiments can store such data in such data structure(s) and read such data from such data structure(s).

Various embodiments can be implemented via computer-executable instructions that can run on one or more computers, and/or in combination with other program modules and/or as a combination of hardware and software.

Various embodiments can be implemented using various computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

Various embodiments can be implemented in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

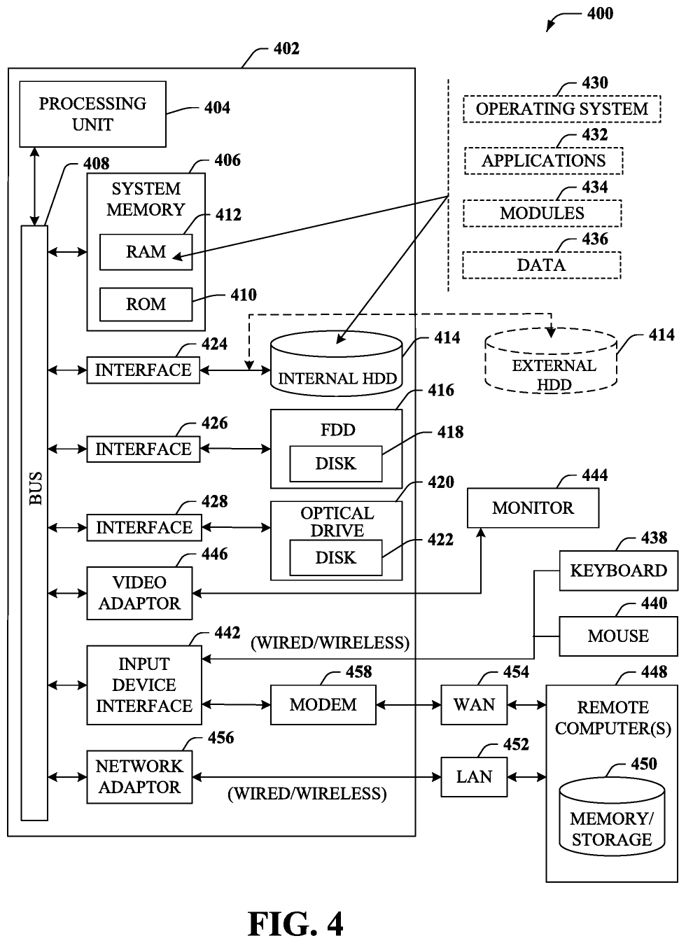

Referring now to FIG. 4, an example computing environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
identifying an initial set of content schedule constraints including an initial plurality of values for two or more of price, available inventory, target audience, media content, number of impressions, placement dates, and placement times;
generating a preliminary advertising schedule based on the initial set of content schedule constraints;
calculating reach and average frequency based on the preliminary advertising schedule, resulting in a first calculated reach and a first calculated average frequency;
updating one or more of the initial plurality of values of the initial set of content schedule constraints based on the first calculated reach and the first calculated average frequency, the updating resulting in an updated set of content schedule constraints, the updated set of content schedule constraints having one or more values of only some constituent content schedule constraints thereof differ from one or more values of corresponding content schedule constraints of the initial set of content schedule constraints; and
generating a first updated advertising schedule based on the updated set of content schedule constraints.

2. The device of claim 1, wherein the updating the one or more of the initial plurality of values facilitates optimizing for both reach and ratings.

3. The device of claim 1, wherein the updating the one or more of the initial plurality of values facilitates optimizing for reach only.

4. The device of claim 1, wherein the updating the one or more of the initial plurality of values facilitates optimizing for ratings only.

5. The device of claim 1, wherein the operations further comprise:
calculating another reach and another average frequency based on the first updated advertising schedule, resulting in a second calculated reach and a second calculated average frequency;
updating the updated set of content schedule constraints based on the second calculated reach and the second calculated average frequency, the updating of the updated set of content schedule constraints resulting in a second updated set of content schedule constraints, the second updated set of content schedule constraints having one or more values of only some constituent content schedule constraints thereof differ from one or more values of corresponding content schedule constraints of the updated set of content schedule constraints; and
generating a second updated advertising schedule based on the second updated set of content schedule constraints.

6. The device of claim 5, wherein the operations further comprise:
selecting either the first updated advertising schedule or the second updated advertising schedule in accordance with an optimization goal.

7. The device of claim 6, wherein the initial set of content schedule constraints comprises a network-daypart.

8. A machine-readable storage medium comprising executable instructions that, when executed by a processing system including a processor, facilitate performance of operations, the operations comprising:
initializing a set of content schedule constraints including two or more of price, available inventory, target audience, media content, number of impressions, placement dates, and placement times, wherein the initializing results in an initial set of content schedule constraints having a plurality of initial values;
generating a first advertising schedule based on the plurality of initial values of the initial set of content schedule constraints;
determining, based on the first advertising schedule, a first reach and a first average frequency;
modifying one or more of the plurality of initial values of the initial set of content schedule constraints based on the first reach and the first average frequency, the modifying resulting in a modified set of content schedule constraints, the modified set of content schedule constraints having one or more values of only some constituent content schedule constraints thereof differ from one or more values of corresponding content schedule constraints of the initial set of content schedule constraints; and
generating a second advertising schedule based on the modified set of content schedule constraints.

9. The machine-readable storage medium of claim 8, wherein the initializing is based on input from a user specifying one or more of the content schedule constraints of the initial set of content schedule constraints, input from the user specifying one or more of the plurality of initial values, or any combination thereof.

10. The machine-readable storage medium of claim 9, wherein the initializing is based on machine learning to automatically generate one or more of the content schedule constraints of the initial set of content schedule constraints, to automatically generate one or more of the plurality of initial values, or any combination thereof.

11. The machine-readable storage medium of claim 10, wherein the machine learning is based on historical campaign data.

12. The machine-readable storage medium of claim 8, wherein the modifying the one or more of the plurality of initial values of the initial set of content schedule constraints facilitates optimizing for both reach and ratings.

13. The machine-readable storage medium of claim 8, wherein the modifying the one or more of the plurality of initial values of the initial set of content schedule constraints facilitates optimizing for reach only.

14. The machine-readable storage medium of claim 8, wherein the modifying the one or more of the plurality of initial values of the initial set of content schedule constraints facilitates optimizing for ratings only.

15. A method comprising:
identifying, by a processing system including a processor, a set of content schedule constraints including a plurality of values for two or more of price, available inventory, target audience, media content, number of impressions, placement dates, and placement times;
determining, by the processing system, an advertising schedule based on the set of content schedule constraints:
calculating reach and average frequency based on the advertising schedule, resulting in a calculated reach and a calculated average frequency;
updating one or more of the plurality of values of the set of content schedule constraints based on the calculated reach and the calculated average frequency, the updating resulting in an updated set of content schedule constraints, the updated set of content schedule constraints having one or more values of only some constituent content schedule constraints thereof differ from one or more values of corresponding content schedule constraints of an immediately prior set of content schedule constraints;
generating an updated advertising schedule based on the updated set of content schedule constraints; and
iterating the calculating, the updating, and the generating, wherein the calculating is iteratively performed based on each immediately prior updated advertising schedule, wherein the updating is iteratively performed based on each immediately prior calculated reach and each immediately prior calculated average frequency, and wherein the generating is iteratively performed based on each immediately prior updated set of content schedule constraints.

16. The method of claim 15, wherein the iterating terminates after the iterating has been carried out a predetermined number of times.

17. The method of claim 15, wherein the iterating terminates after the iterating has been carried out a predetermined amount of time.

18. The method of claim 15, wherein the iterating terminates after a rate of change in the reach falls below a threshold value.

19. The method of claim 18, wherein the rate of change in the reach is measured by a difference in value of the reach from one iteration to another iteration.

20. The method of claim 15, wherein the reach is calculated at a network-daypart level.
